(19) United States
(12) Patent Application Publication
(10) Pub. No.: US 2004/0206385 A1
(43) Pub. Date: Oct. 21, 2004

(54) Lift assist apparatus

(76) Inventor: Lawrence Turlington, Franklin, NC (US)

Correspondence Address: JASON A. BERNSTEIN, POWELL, GOLDSTEIN, FRAZER & MURPHY LLP, 16TH FLOOR, 191 PEACHTREE STREET, NE, ATLANTA, GA, 30303-1736, US

(21) Appl. No.: 10/419,314

(22) Filed: Apr. 17, 2003

(51) Int. Cl. A61H 3/00

(52) U.S. Cl. 135/67

(57) ABSTRACT

A lift assist apparatus for moving an individual from a seated to a standing position comprises two vertical supports wherein each vertical support comprises a vertical slot. A top rod is attached to the upper portion of each vertical support and a bottom rod is attached to the lower portion of each vertical support. A horizontal arm is movably connected to each vertical support. Motor driven belts located within the vertical slots of the vertical supports cause the horizontal arms to simultaneously move up and down along the vertical supports. Alternatively, a piston located in each vertical slot is used to move the horizontal arms along the vertical supports. The horizontal arms provide support for an individual moving to as seated or standing position. The lift assist apparatus may also be comprised of a single vertical support. The lift assist apparatus is typically mounted to a wall.

### FIELD OF THE INVENTION

The present invention relates to a lifting apparatus for disabled individuals. More particularly, the present invention provides an apparatus to assist a person when moving to a sitting or standing position.

### BACKGROUND OF THE INVENTION

As a result of various medical conditions such as muscular disease, arthritis, joint injuries, etc., as well as advanced age, many individuals find themselves physically challenged. This is especially the case when moving to a sitting or standing position. Disabled individuals often find themselves stranded or immobile once they are sitting on a chair, bed, sofa, etc., and discover that they cannot raise to a standing position without assistance. Similarly, these individuals often find it just as challenging to move to a seated position once they are standing.

Devices exist that permit physically challenged individuals to brace or support themselves as they stand or sit. However, such devices still require a great deal of physical exertion on the part of the disabled individual as they are required to pull themselves up to a standing position or lower their bodies to seated position. Furthermore, the assistance of another person is usually necessary when most disabled individuals use such existing mobility support devices. Accordingly, these devices may not be suitable for many disabled individuals.

### SUMMARY OF THE INVENTION

The present invention solves the above-described problem by providing a lift assist apparatus that aids an individual when moving to a standing or sitting position without the assistance of another person. The lift assist apparatus includes a first vertical support having first and second walls and a vertical slot formed therebetween. The apparatus also includes a second vertical support having first and second walls and a vertical slot formed therebetween. A top rod is rotatably connected to the upper portion of each vertical support, and a bottom rod is rotatably connected to the lower portion of each vertical support. A first belt is located within the vertical slot of the first vertical support and is operatively associated with the top rod and bottom rod. Similarly, a second belt is located within the vertical slot of the second vertical support and is operatively associated with the top rod and bottom rod. A motor rotates the bottom rod, and as a result the first and second belts cause rotation of the top rod. A first horizontal arm is movably disposed within the vertical slot within the first vertical support, and a second horizontal arm is movably disposed within the vertical slot within the second vertical support. The first horizontal arm is connected to the first belt and a second horizontal arm is connected to the second belt. The first horizontal arm moves up or down along the first vertical support and the second horizontal arm moves up or down along the second vertical support in response to rotation of the top and bottom rods. The horizontal arms support an individual when moving to a sitting or standing position.

More particularly, a first vertical support guide may be located within the vertical slot of the first vertical support, and a second vertical support guide may be located within the vertical slot of the second vertical support. The first horizontal arm is attached to the first vertical support guide and the second horizontal arm is attached to the second vertical support guide. In addition, the first and second vertical support guides are connected to the first and second belts, respectively. The first and second vertical support guides move up and down within the respective vertical slots of the first and second vertical supports in response to rotation of the top and bottom rods.

In an alternative embodiment, the lift assist apparatus of the present invention includes a first vertical support having first and second walls and a vertical slot formed therebetween. The apparatus also includes a second vertical support having first and second walls and a vertical slot formed therebetween. A top rod is connected to the upper portion of each vertical support, and a bottom rod is connected to the lower portion of each vertical support. A first piston is located within the vertical slot of the first vertical support and a second piston is located within the vertical slot of the second vertical support. A first horizontal arm is movably disposed within the vertical slot of the first vertical support, and a second horizontal arm is movably disposed within the vertical slot of the second vertical support. The first piston causes the first horizontal arm to move up or down along the first vertical support and the second piston causes the second horizontal arm to move up or down along the second vertical support. The horizontal arms provide support for an individual when moving to a sitting or standing position.

A first vertical support guide may be located within the vertical slot of the first vertical support, and a second vertical support guide may be located within the vertical slot of the second vertical support. The first horizontal arm is attached to the first vertical support guide and the second horizontal arm is attached to the second vertical support guide. In addition, the first and second vertical support guides are connected to the first and second pistons, respectively. The first piston causes the first vertical support guide to move up or down within the vertical slot of the first vertical support, and the second piston causes the second vertical support guide to move up or down within the vertical slot of the second vertical support, thereby raising and lowering the horizontal arms.

In yet another embodiment, the lift assist apparatus of the present invention includes a vertical support having first and second walls and a vertical slot formed therebetween. A horizontal arm is movably disposed within the vertical slot within the vertical support. A first sprocket is located within the vertical slot near the upper end of the vertical support, and a second sprocket is located within the vertical slot near the lower end of the vertical support. A belt is located within the vertical slot and engages the first and second sprockets. The horizontal arm is connected to the belt. A motor rotates the belt causing the horizontal arm to move up or down along the vertical support. The horizontal arm provides support to a disabled individual when moving to a sitting or standing position.

A fourth embodiment of the present invention relates to a lift assist apparatus comprising a vertical support having first and second walls and a vertical slot formed therebetween. A horizontal arm is movably disposed within the vertical slot within the vertical support. A piston is located within the vertical slot of the vertical support, wherein the piston causes the horizontal arm to move up or down along the vertical support. The horizontal arm provides mobility support for an individual when moving to a standing or seated position.

Other features and advantages of the present invention will become apparent upon reading the following detailed description of embodiments of the invention, when taken in conjunction with the appended claims.

### BRIEF DESCRIPTION OF THE DRAWINGS

The invention is illustrated in the drawings in which like reference characters designate the same or similar parts throughout the figures of which:

FIG. 1 is a perspective view of a lift assist apparatus made in accordance with one exemplary embodiment of the present invention.

FIG. 2 is a fragmentary perspective view of a sprocket and belt of FIG. 1.

FIG. 3 is a fragmentary perspective view of a horizontal arm and vertical support guide of FIG. 1.

FIG. 4 is a perspective view of a lift assist apparatus made in accordance with a first alternative exemplary embodiment of the present invention.

FIG. 5 is a fragmentary perspective view of a piston and vertical support guide of FIG. 4.

FIG. 6 is a perspective view of a lift assist apparatus made in accordance with a second alternative exemplary embodiment of the present invention.

### DETAILED DESCRIPTION OF THE INVENTION

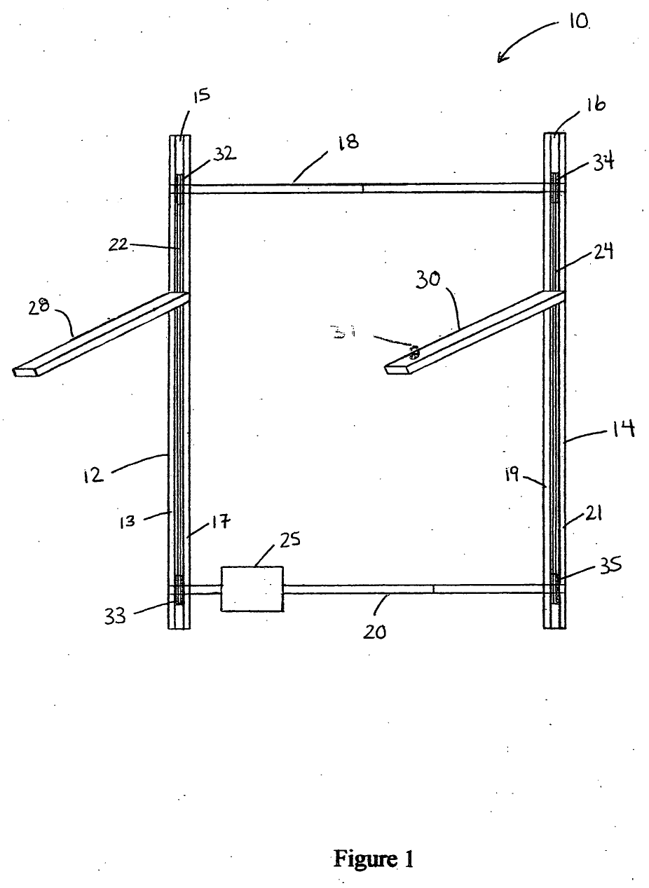

Referring to FIG. 1, a lift assist apparatus 10 is shown according to one exemplary embodiment of the present invention which includes a first vertical support 12 and a second vertical support 14. Typically the first vertical support 12 is located parallel to the second vertical support 14, but the first vertical support 12 may also be located at an angle to the second vertical support 14. The first vertical support 12 includes a first wall 13 and second wall 17, and a vertical slot 15 formed therebetween. Similarly, the second vertical support 14 includes a first wall 19 and a second wall 21, and a vertical slot 16 formed therebetween. A top rod 18 is rotatably connected to the upper portion of the first vertical support 12 and the second vertical support 14, wherein the top rod passes through the vertical slot 15 and 16 of each vertical support. More particularly, the top rod 18 is rotatably connected to the first vertical support 12 and second vertical support 14 by passing through at least one orifice in one of the walls 13 and 17 of the first vertical support, and by passing through at least one orifice in one of the walls 19 and 21 of the second vertical support. Similarly, a bottom rod 20 is rotatably connected to the lower portion of the first and second vertical supports 12 and 14, wherein the bottom rod passes through the vertical slot 15 and 16 of each vertical support. Specifically, the bottom rod 20 is rotatably connected to the first vertical support 12 and second vertical support 14 by passing through at least one orifice in one of the walls 13 and 17 of the first vertical support, and by passing through at least one orifice in one of the walls 19 and 21 of the second vertical support 14. The top rod 18 and bottom rod 20 may each be adjustable rods wherein the length of the rods is varied depending upon the location of the lift assist apparatus 10 or the size of the person using the device. Preferably, the top rod 18 and the bottom rod 20 each have a length between approximately 1.5 feet and 4 feet. More preferably, the length of the top rod 18 and the bottom rod 20 is between about 2 feet and 3 feet. In addition, the height of the first and second vertical supports 12 and 14 will vary depending upon the location of the lift assist apparatus 10 and the size of the individual who will be utilizing the device. Typically, the height of the first and second vertical supports 12 and 14 may be between about 4 feet and 8 feet. Preferably, the height of the first and second vertical supports 12 and 14 is between about 5 feet and 7 feet. It is to be understood that the vertical supports 12 and 14 may be shorter or longer than the typical height and may also be angled toward or away from each other.

A first belt 22 is disposed in the vertical slot 15 of the first vertical support 12 and is operatively associated with the portion of the top rod 18 and bottom rod 20 located in the first vertical slot 15. A second belt 24 is located within the vertical slot 16 of the second vertical support 14 and is operatively associated with the portion of the top rod 18 and bottom rod 20 located in the second vertical slot 16. A motor 25 is used to rotate the bottom rod 20. As a result, the first belt 22 and second belt 24 cause rotation of the top rod 18. Any motor known to those having skill in the art may be used in the present invention that is capable of causing rotation of the bottom rod 20.

A first horizontal arm 28 is movably disposed within the vertical slot 15 within the first vertical support 12 and is connected to the first belt 22. A second horizontal arm 30 is movably disposed within the vertical slot 16 within the second vertical support 14 and is connected to the second belt 24. The first and second horizontal arms 28 and 30 preferably move up or down simultaneously along the first and second vertical supports 12 and 14, respectively, in response to rotation of the top rod 18, bottom rod 20, and first and second belts 22 and 24. The first and second horizontal arms 28 and 30 provide support for an individual moving to a sitting or standing position. Specifically, an individual in a sitting position may rest his or her forearms on the first and second horizontal arms 28 and 30. As the horizontal arms 28 and 30 are raised, the individual is lifted to a standing position. Alternatively, an individual already in a standing position may rest his or her forearms against the first and second horizontal arms 28 and 30, and as the horizontal arms are lowered along the vertical supports 12 and 14, the individual may be lowered to a sitting position. If desired, the first and second horizontal arms 28 and 30 may be padded to provide comfort to the user. The direction of the horizontal arms 28 and 30 along the first and second vertical supports 12 and 14 may be controlled through the use of any electromechanical switch or sensor 31 (direct or remotely activated) known to those having skill in the art. The switch 31 may be placed on either or both horizontal arms 28 and 30, on the floor as a foot switch, on the wall near the apparatus 10 or at any other appropriate location. The switch 31 may also be a sensor which remotely activates the apparatus 10 motor.

The first and second horizontal arms 28 and 30 may be adjustable so that the length of the arms can be varied depending upon the size of the individual using the lift assist apparatus 10. For example, each horizontal arm 28 and 30 may comprise at least two sections which can telescope with respect to one another. In 20 addition, the angle of the first and second horizontal arms 28 and 30 in relation to the vertical supports 12 and 14 may be adjusted. For example, the first and second horizontal arms 28 and 30 may be positioned to slant downward or inward, in order to more readily assist a person in moving to a sitting position.

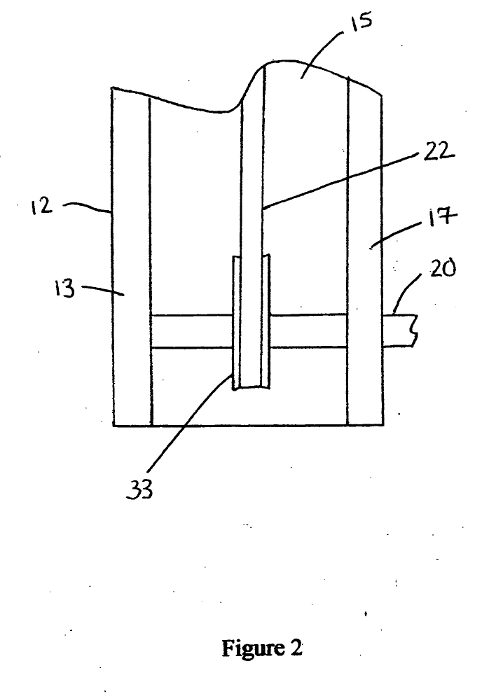

The first and second belts 22 and 24 may be comprised of any material which is capable of rotating the top rod 18 and bottom rod 20 and also supporting the weight of the first and second horizontal arms 28 and 30, in addition to the individual using the lift assist apparatus 10. For example, the first belt 22 and second belt 24 may be comprised of rubber. Preferably, the first and second belts 22 and 24 are each metal chains. If the first and second belts 22 and 24 are chains, preferably a sprocket is located at each end of the top and bottom rods 18 and 20. The sprockets 32, 33, 34 and 35 are preferably located within the vertical slots of the first and second vertical supports 12 and 14. The first belt 22 engages the sprockets 32 and 33 located at one end of the top rod 18 and bottom rod 20. The second belt 24 engages the sprockets 34 and 35 located at the other end of the top rod 18 and bottom rod 20. A detailed view of the first belt 22 and sprocket 33 is displayed in FIG. 2. Alternatively, the sprockets 32, 33, 34 and 35 and belts 22 and 24 can be located outside of the vertical supports 12 and 14.

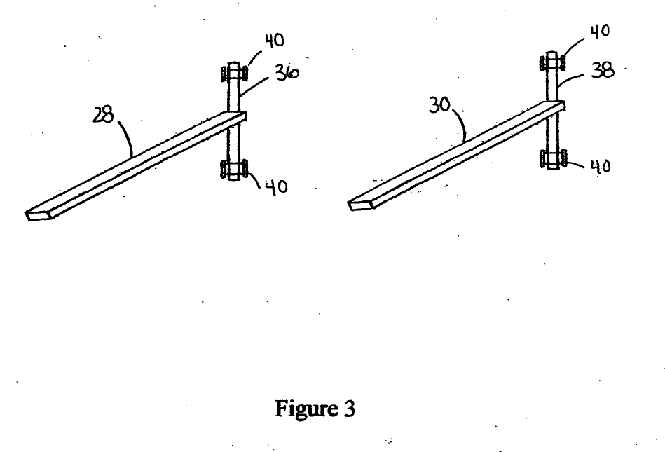

The lift assist apparatus 10 of the present invention may also include two vertical support guides 36 and 38 as shown in FIG. 3. The first vertical support guide 36 is located within the vertical slot 15 of the first vertical support 12, and the second vertical support guide 38 is located within the vertical slot 16 of the second vertical support 14. In addition, the first and second vertical support guides 36 and 38 are connected to the first and second belts 22 and 24, respectively. The vertical support guides 36 and 38 may be connected to the first and second belts 22 and 24 by any method known to those having skill in the art, including, but not limited to the use of pins, axles, dowels, or the like. Furthermore, the first vertical support guide 36 is connected to the first horizontal arm 28, and the second vertical support guide 38 is connected to the second horizontal arm 30. The first and second vertical support guides 36 and 38 simultaneously move up or down within the vertical slots 15 and 16 of the first and second vertical supports 12 and 14, respectively, in response to rotation of the top rod 18, bottom rod 20, and first and second belts 22 and 24. Preferably, at least one roller 40 is attached to each vertical support guide 36 and 38 in order to aid the movement of the vertical support guides within the vertical slots 15 and 16 of the first and second vertical supports 12 and 14. More preferably, two rollers 40 are attached to each vertical support guide 36 and 38.

The first and second vertical supports 12 and 14, upper rod 18, lower rod 20, first horizontal arm 28, second horizontal arm 30, and first and second vertical support guides 36 and 38 may be comprised of any material known to those having ordinary skill in the art which is capable of allowing proper operation of the lift assist apparatus 10. Preferably, these components are comprised of stainless steel or high strength aluminum.

The lift assist apparatus 10 of the present invention may be a stand alone device, for example, but not as a limitation, by including a base frame structure which rests on the ground, and to which the vertical supports 12 and 14 are attached) or more preferably may be mounted on a wall. Specifically, the first vertical support 12 and second vertical support 14 may be mounted to a wall through the use of brackets, cleats, anchors, glue or any other suitable means. The vertical supports 12 and 14 may also include holes or slots to accommodate various fastening means, such as bolts, screws, or the like. The vertical supports 12 and 14 may be embedded or constructed as part of the wall. The lift assist apparatus 10 may be located near a lavatory or chair and positioned so that the first and second horizontal arms 28 and 30 flank each side of the lavatory or chair.

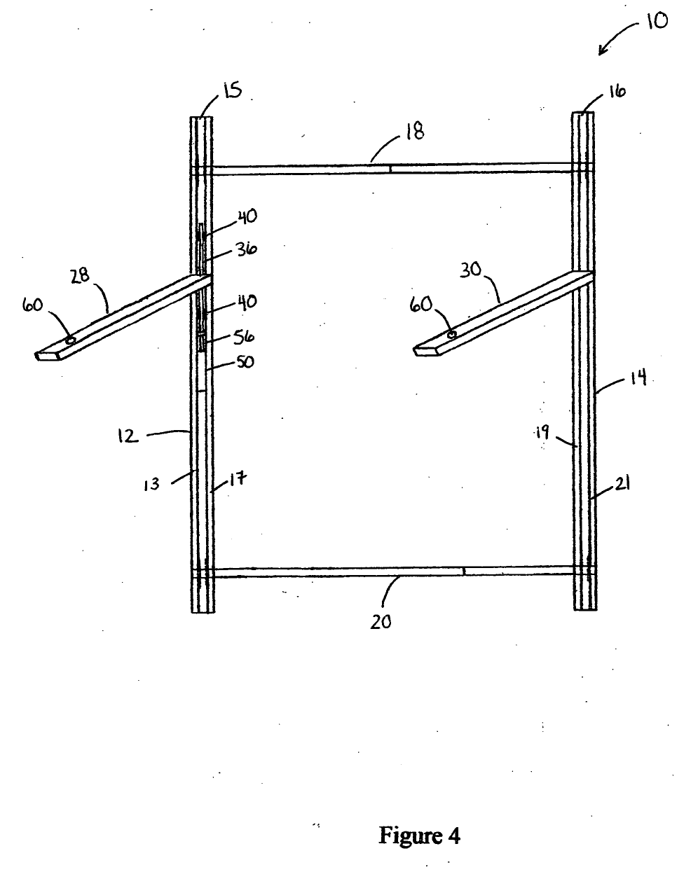

A first alternative exemplary embodiment of the present invention is displayed in FIG. 4. In this embodiment, the lift assist apparatus 100 includes a first vertical support 12 and a second vertical support 14. Typically the first vertical support 12 is located parallel to the second vertical support 14. The first vertical support 12 includes a first wall 13 and second wall 17, and a vertical slot formed therebetween. Similarly, the second vertical support 14 includes a first wall 19 and a second wall 21, and a vertical slot 16 formed therebetween. A top rod 18 is connected to the upper portion of the first vertical support 12 and the second vertical support 14. More particularly, the top rod 18 is connected to the first vertical support 12 and second vertical support 14 by passing through at least one orifice in one of the walls 13 and 17 of the first vertical support, and by passing through at least one orifice in one of the walls 19 and 21 of the second vertical support. Similarly, a bottom rod 20 is connected to the lower portion of the first and second vertical supports 12 and 14. Specifically, the bottom rod 20 is connected to the first vertical support 12 and second vertical support 14 by passing through at least one orifice in one of the walls 13 and 17 of the first vertical support, and by passing through at least one orifice in one of the walls 19 and 21 of the second vertical support. The top rod 18 and bottom rod 20 may each be adjustable rods wherein the length of the rods is varied depending upon the location of the lift assist apparatus 100 or the size of the person using the device; Preferably, the top rod 18 and the bottom rod 20 each have a length between approximately 1.5 feet and 4 feet. More preferably, the length of the top rod 18 and the bottom rod 20 is between about 2 feet and 3 feet. In addition, the height of the first and second vertical supports 12 and 14 will vary depending upon the location of the lift assist apparatus 100 and the size of the individual who will be utilizing the apparatus. Typically, the height of the first and second vertical supports 12 and 14 is between about 4 feet and 8 feet. Preferably, the height of the first and second vertical supports 12 and 14 is between about 5 feet and 7 feet.

A first piston 50 is disposed in the vertical slot 15 of the first vertical support 12, and a second piston 52 is located within the vertical slot 16 of the second vertical support 14. Any piston, e.g. hydraulic or pneumatic, known to those having ordinary skill in the art may be used in the present invention. Alternatively, other suitable actuatable mechanisms for moving the horizontal arms 28 and 30 from a first to a second position may be used. Preferably, the first piston 50 and the second piston 52 are hydraulic pistons. The first and second pistons 50 and 52 may preferably move up or down simultaneously within the respective vertical slots 15 and 16. The upward or downward movement of the pistons 50 and 52 may be controlled through the use of any electromechanical switch or sensor (direct or remotely activated) known to those having ordinary skill in the art.

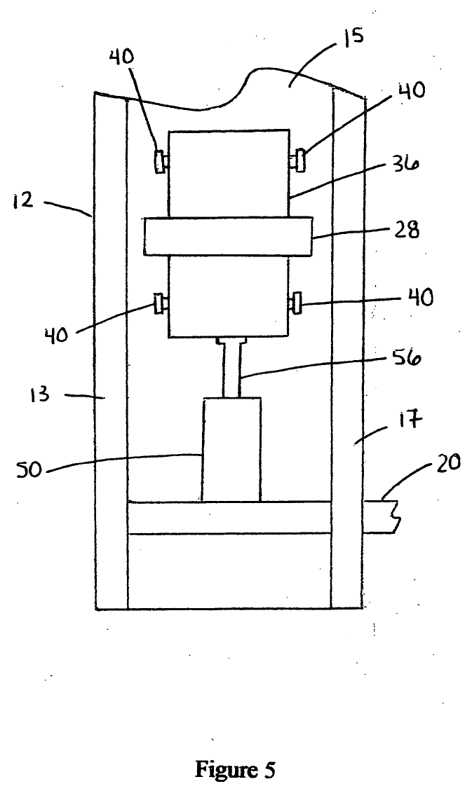

As shown in FIG. 5, the underside of a first horizontal arm 28 rests on or is connected to the activatable rod 56 of the first piston 50, and a second horizontal arm 30 is connected to the second piston 52 in a similar manner. The first and second horizontal arms 28 and 30 simultaneously move up or down along the first and second vertical supports 12 and 14, respectively, in response to the movement of the first piston and the second piston. The first and second horizontal arms 28 and 30 provide support for an individual moving to a sitting- or standing position. Specifically, an individual in a sitting position may rest his or her forearms on the first and second horizontal arms 28 and 30. The individual may press a button or switch 60 on the horizontal arms 28 or 30 to activate the pistons 50 and 52. Alternatively, a button, switch or pedal located near the base of the apparatus 100, may be pressed by an individuals foot to activate the pistons 50 and 52. The switch 60 is operatively connected to the piston or a control device (not shown). The pistons 50 and 52 are preferably selected for smooth controlled movement so that the horizontal arms 28 and 30 and the user's arms are raised gently and without trauma or discomfort to the user. Optionally, an emergency stop switch (not shown) may be included, such as on the horizontal arms 28 and 30 in the event the pistons must be stopped quickly. The horizontal arms 28 and 30 are raised, the individual is lifted to a standing position. Alternatively, an individual already in a standing position may rest his or her forearms against the first and second horizontal arms 28 and 30, and as the horizontal arms are lowered along the vertical supports 12 and 14, the individual may be moved to a seated position. If desired, the first and second horizontal arms 28 and 30 may be padded to provide comfort to the user.

The first and second horizontal arms 28 and 30 may be adjustable so that the length of the arms can be varied depending upon the size of the individual using the lift assist apparatus 100. For example, each horizontal arm 28 and 30 may comprise at least two sections which can telescope with respect to one another. In addition, the angle of the first and second horizontal arms 28 and 30 in relation to the vertical supports 12 and 14 may be adjusted. For example, the first and second horizontal arms 28 and 30 may be positioned to slant downward or inward, in order to more readily assist a person in moving to a sitting position.

The lift assist apparatus 100 of the present invention may also include two vertical support guides 36 and 38 as indicated in FIG. 2. The first vertical support guide 36 is located within the vertical slot of the first vertical support 12, and the second vertical support guide 38 is located within the vertical slot of the second vertical support 14. In addition, the first and second vertical support guides 36 and 38 are connected to the first and second pistons 50 and 52, respectively. The vertical support guides 36 and 38 may be connected to the first and second pistons 50 and 52 by any method known to those having skill in the art, including, but not limited to the use of pins. The first vertical support guide 36 is also connected to the first horizontal arm 28, and the second vertical support guide 38 is connected to the second horizontal arm 30. The first and second vertical support guides 36 and 38 simultaneously move up or down within the vertical slots of the first and second vertical supports 12 and 14, respectively, in response to movement of the first piston and the second piston, thereby raising and lowering the horizontal arms 28 and 30, respectively. Preferably, at least one roller 40 is attached to each vertical support guide 36 and 38 in order to aid the movement of the vertical support guides within the vertical slots 15 and 16 of the first and second vertical supports 12 and 14. More preferably, two rollers 40 are attached to each vertical support guide 36 and 38.

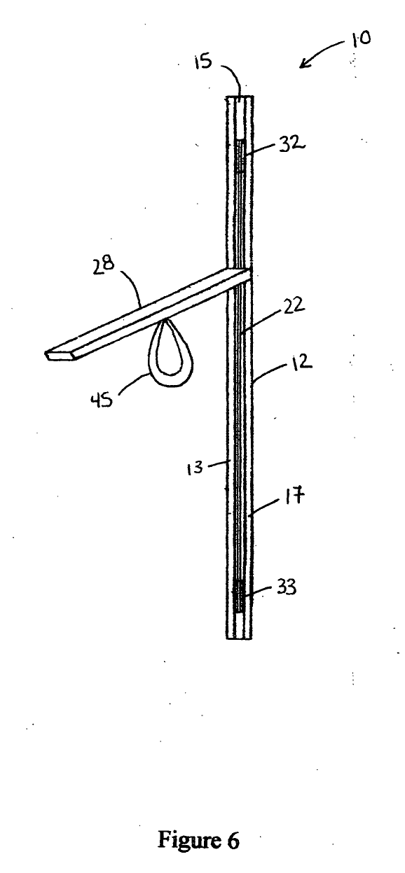

A second alternative exemplary embodiment of the present invention is displayed in FIG. 6. In this embodiment, a single vertical support 12 is utilized in a lift assist apparatus 200. The vertical support 12 includes a first wall 13, a second wall 17, and a vertical slot 15 formed therebetween. Typically, the height of the vertical support 12 is between about 4 feet and 8 feet. Preferably, the height of the vertical support 12 is between about 5 feet and 7 feet.

A first sprocket 32 is located within the vertical slot 15 and near the upper end of the vertical support 12. A second sprocket 33 is located within the vertical slot 15 and near the lower end of the vertical support 12. A belt 22 is disposed in the vertical slot 15 of the vertical support 12 and wraps around the first and second sprockets 32 and 33. A motor 25 is connected to the first or second sprocket 32 and 33 and is used to rotate the belt 22 around the sprockets. Any motor known to those having skill in the art may be used in the present invention that is capable of causing rotation of the belt 22.

A horizontal arm 28 is movably disposed within the vertical slot 15 within the vertical support 12. The horizontal arm 28 is connected to the belt 22, wherein the horizontal arm 28 moves up or down along the vertical support 12 in response to rotation of the belt 22. The horizontal arm 28 provides support for a disabled individual moving to a seated or standing position. If desired, the horizontal arm 28 may be padded to provide comfort to the user. The direction of the horizontal arm 28 along the vertical support 12 may be controlled through the use of any electromechanical switch or sensor (direct or remotely activated) known to those having skill in the art.

The belt 22 may be comprised of any material which is capable of supporting the weight of the horizontal arm 28, in addition to the individual using the lift assist apparatus 200. For example, the belt 22 may be comprised of rubber. Preferably, the belt 22 is a metal chain.

The horizontal arm 28 may be adjustable (e.g. telescoping) so that the length of the arm can be varied depending upon the size of the individual using the lift assist apparatus 200. In addition, the angle of the horizontal arm 28 in relation to the vertical support 12 may be varied. For example, the horizontal arm 28 may be positioned to slant downward or inward, in order to more readily assist a person in moving to sitting position. Furthermore, a strap 70 may be attached to the horizontal arm 28. An individual may hold onto or support themselves with the strap 70, in addition to or instead of using the horizontal arm 28. The strap 45 may be comprised of any material which is capable of supporting the weight of an individual. Preferably, the strap 45 is comprised of cloth or leather. Instead, of a strap 70, a T-bar, suspended ball or ring, or other structure a user can grasp for additional support may be attached to the horizontal arm 28 for the same purpose.

A vertical support guide 36 (shown in FIG. 2) may also be located within the vertical slot 15 of the vertical support 12. The vertical support guide 36 is connected to the belt 22 and the horizontal arm 28. The vertical support guide 36 may be connected to the belts 22 by any method known to those having skill in the art, including, but not limited to the use of pins, axles, dowels or the like. The vertical support guide 36 moves up or down within the vertical slot 15 of the vertical support 12 in response to rotation of the belt 22. Preferably, at least one roller 40 is attached to the vertical support guide 36 in order to aid the movement of the vertical support guide within the vertical slot 15. More preferably, two rollers 40 are attached to the vertical support guide 36.

Alternatively, instead of using a belt 22, sprockets 32 and 33 and motor 25, movement of the horizontal arm 28 or vertical support guide 36 in this embodiment may be accomplished through the use of a piston as described in detail above in the first alternative exemplary embodiment.

This embodiment of the lift assist apparatus 10 may be a stand alone unit (e.g., by including a base frame structure which rests on the ground, and to which the vertical supports 12 is attached) or more preferably may be mounted on a wall through the use of brackets. Specifically, the vertical support 12 may be mounted to a wall near a chair or lavatory.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

It should further be noted that any patents, applications and publications referred to herein are incorporated by reference in their entirety.

What is claimed is:

1. A device for assisting a disabled individual to stand or sit comprising:
a first vertical support having first and second walls and a vertical slot formed therebetween;
a second vertical support having first and second walls and a vertical slot formed therebetween;
a top rod rotatably connected to an upper portion of each vertical support;
a bottom rod rotatably connected to a lower portion of each vertical support;
a motor for rotating the bottom rod;
a first horizontal arm movably disposed within the vertical slot within the first vertical support;
a second horizontal arm movably disposed within the vertical slot within the second vertical support;
a first belt located within the vertical slot of the first vertical support wherein the first belt is operatively associated with the top rod and the bottom rod; and
a second belt located within the vertical slot of the second vertical support wherein the second belt engages the top rod and the bottom rod;
wherein the first and second belts cause rotation of the top rod, wherein the first horizontal arm support moves up or down along the first vertical support and the second horizontal arm support moves up or down along the second vertical support in response to rotation of the top and bottom rods, and wherein the horizontal arms support an individual when moving to a sitting or standing position.

2. The device of claim 1, wherein the first horizontal arm is connected to the first belt and the second horizontal arm is connected to the second belt.

3. The device of claim 1, further comprising:
a first vertical support guide located within the vertical slot of the first vertical support; and
a second vertical support guide located within the vertical slot of the second vertical support;
wherein the first horizontal arm is connected to the first vertical support guide and the second horizontal arm is connected to the second vertical support guide, wherein the first vertical support guide is attached to the first belt and the second vertical support guide is attached to the second belt, and wherein the first vertical support guide moves up or down within the vertical slot of the first vertical support and the second vertical support guide moves up or down within the vertical slot of the second vertical support in response to rotation of the top and bottom rods.

4. The device of claim 3, further comprising:
at least one roller attached to the first vertical support guide for movement of the first vertical support guide within the vertical slot of the first vertical support; and
at least one roller attached to the second vertical support guide for movement of the second vertical support guide within the vertical slot of the second vertical support.

5. The device of claim 1, further comprising:
a sprocket located at each end of the top rod and bottom rod;
wherein the first belt is a chain which engages the sprockets located at one end of the top rod and bottom rod and the second belt is a chain which engages the sprockets located at an opposite end of the top rod and bottom rod.

6. The device of claim 1, wherein the vertical supports, top rod, bottom rod and horizontal arms are comprised of stainless steel.

7. The device of claim 1, further comprising a first and second bracket for mounting the first vertical support and second vertical support to a wall.

8. The device of claim 1, wherein the length of each horizontal arm is adjustable.

9. The device of claim 8, wherein each horizontal arm comprises at least two sections which can telescope which respect to one another.

10. A device for assisting a disabled individual to stand or sit comprising:
a first vertical support having first and second walls and a vertical slot formed therebetween;
a second vertical support having first and second walls and a vertical slot formed therebetween;
a top rod connected to an upper portion of each vertical support;
a bottom rod connected to a lower portion of each vertical support;
a first horizontal arm disposed within the vertical slot within the first vertical support;
a second horizontal arm movably disposed within the vertical slot within the second vertical support;
a first piston located within the vertical slot of the first vertical support; and
a second piston located within the vertical slot of the second vertical support;
wherein the first piston causes the first horizontal arm support to move up or down along the first vertical support and the second piston causes the second horizontal arm support to move up or down along the second vertical support, and wherein the horizontal arms support an individual when moving to a sitting or standing position.

11. The device of claim 10, further comprising:
a first vertical support guide located within the vertical slot of the first vertical support; and
a second vertical support guide located within the vertical slot of the second vertical support;
wherein the first horizontal arm is connected to the first vertical support guide and the second horizontal arm is connected to the second vertical support guide, wherein the first piston causes the first vertical support guide to move up or down within the vertical slot of the first vertical support and the second piston causes the second vertical support guide to move up or down within the vertical slot of the second vertical support.

12. The device of claim 11, further comprising:
at least one roller attached to the first vertical support guide for movement of the first vertical support guide within the vertical slot of the first vertical support; and
at least one roller attached to the second vertical support guide for movement of the second vertical support guide within the vertical slot of the second vertical support.

13. The device of claim 10, wherein the vertical supports, top rod, bottom rod and horizontal arms are comprised of stainless steel.

14. The device of claim 10, further comprising a first and second bracket for mounting the first vertical support and second vertical support to a wall.

15. The device of claim 10, wherein the length of each horizontal arm is adjustable.

16. A device for assisting a disabled individual to stand or sit comprising:
a vertical support having first and second walls and a vertical slot formed therebetween;
a first sprocket located within the vertical slot near the upper end of the vertical support;
a second sprocket located within the vertical slot and near the lower end of the vertical support;
a belt located within the vertical slot which engages the first and second sprockets;
a motor for rotating the belt; and
a horizontal arm movably disposed within the vertical slot within the vertical support and connected to the belt;
wherein the horizontal arm moves up or down along the vertical support in response to rotation of the belt, and wherein the horizontal arm supports an individual when moving to a sitting or standing position.

17. The device of claim 16, further comprising:
a vertical support guide located in the vertical slot of the vertical support wherein the horizontal arm is connected to the vertical support guide, wherein the vertical support guide is connected to the belt, and wherein the vertical support guide moves up or down within the vertical slot in response to rotation of the belt.

18. The device of claim 16, further comprising:
a strap attached to the horizontal arm to provide support to the individual when moving to a sitting or standing position.

19. The device of claim 16, further comprising a bracket for mounting the vertical support to a wall.

20. A device for assisting a disabled individual to stand or sit comprising:
a vertical support having first and second walls and a vertical slot formed therebetween:
a horizontal arm movably disposed within the vertical slot within the vertical support; and
a piston located within the vertical slot of the vertical support;
wherein the piston causes the horizontal arm to move up or down along the vertical support, and wherein the horizontal arm supports an individual when moving to a sitting or standing position.

21. The device of claim 20, further comprising:
a vertical support guide located in the vertical slot of the vertical support wherein the horizontal arm is connected to the vertical support guide and wherein the piston causes the vertical support guide to move up or down within the vertical slot of the vertical support.

22. The device of claim 20, further comprising:
a strap attached to the horizontal arm to provide support to the individual when moving to a sitting or standing position.

23. The device of claim 20, further comprising s bracket for mounting the vertical support to a wall.
